(19) United States
(12) Patent Application Publication
(10) Pub. No.: US 2015/0103460 A1
(43) Pub. Date: Apr. 16, 2015

(54) WELLHEAD MOUNTED TRANSIENT VOLTAGE SURGE SUPPRESSION AND METHOD OF USE THEREOF

(71) Applicant: PM&D Engineering, Inc., Broken Arrow, OK (US)

(72) Inventor: Thomas R. Brinner, Broken Arrow, OK (US)

(21) Appl. No.: 14/476,050

(22) Filed: Sep. 3, 2014

Related U.S. Application Data
(60) Provisional application No. 61/891,469, filed on Oct. 16, 2013.

(51) Int. Cl. H02H 9/00; H02H 1/00; H02H 7/085

(52) U.S. Cl. CPC H02H 9/005; H02H 7/0855; H02H 1/00
USPC 361/111; 29/825

(57) ABSTRACT

The invention is directed to a system and method for lightning strike protection for oil well electric motors and cables, and in particular, an explosion-proof transient voltage surge suppressor that is mounted internally or attached externally to a packer penetrator directly on a wellhead. The transient voltage surge suppressor can be incorporated directly into the packer penetrator pipes along with the power wires. The transient voltage surge suppressor is housed within an explosion-proof box inside or attached to the packer penetrator.

### CROSS REFERENCE TO RELATED APPLICATIONS

This application claims priority to and the benefit of U.S. Provisional Patent Application No. 61/891,469, filed Oct. 16, 2013, which is incorporated by reference in its entirety.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A SEQUENCE LISTING, A TABLE, OR A COMPUTER PROGRAM LISTING APPENDIX

Not Applicable.

### BACKGROUND OF THE INVENTION

1. Field of the Invention

This invention relates generally to lightning protection for oil well submersible pump motors and cables, and more particularly to an explosion-proof transient voltage surge suppressor (TVSS) incorporated into a wellhead power feed-through penetrator or mandrel in order to position the surge suppressor in very close proximity to the oil well equipment intended to be protected.

2. Description of the Related Art

Lightning protection for downhole electrical equipment has long been an area of concern, and the electrical equipment must be protected from transient voltage surges carried in through the power lines. Oil production facilities are a special case for lightning protection because of their remoteness and the fact that they are often the highest objects on the horizon. When the use of natural gas, electrically charged fluids, and unprotected power systems are added in, the protection problem becomes more challenging. Since the area around a wellhead can contain natural gas and is thereby an explosive environment, a device like a TVSS than can produce a spark igniting an explosion is restricted from placement neat the wellhead.

Oil, gas and water wells have a wellbore extending to some depth below the surface. For oil and gas wells the wellbore is lined with a steel casing to strengthen the walls of the borehole and to contain pressurized fluid. To further strengthen the walls of the borehole and prevent ground water contamination, the annular area between the casing and the borehole is typically filled with cement to permanently set the casing in the wellbore. Below the cemented section, the casing is perforated to allow production fluids from the desired formation to enter the wellbore and be retrieved at the surface of the well. Because the steel casing is an exceptionally low-resistance ground, the National Electric Code (NEC) requires the ground conductor of electrical equipment to be connected to the wellhead. However, the wellhead is an explosive environment classified as either Class I division 1 or 2, and to date, this has precluded a close connection of TVSS to it. Since ground wires are mostly inductive, voltage dropping across such inductance reduces the effectiveness of TVSS.

Various types of downhole equipment, such as pumps and similar devices, are used to move production fluids from within the wellbore to the surface. One type of well-known pump is a downhole electrical submersible pump (ESP). The ESP includes and is connected to a downhole motor, which is sealed so that the entire assembly can be submerged in the fluid to be produced. The motor is connected to a power source at the surface and operates beneath the level of the fluid downhole in order to pump the fluid to the surface.

ESPs experience many electrical insulation failures in the motor and power cable due to lightning and switching surges associated with recloser operations to extinguish established arcs. TVSS and surge protection devices (SPD) are similar to lightning arresters but operate on multi-phase power at lower voltages. By limiting the peak value of a voltage impulse, electrical insulation is spared the degrading effect of treeing and outright puncture. TVSS design and proper ground are critically important if equipment is to be saved from lightning damage. Where and how the TVSS is connected directly affects how effective that protection will be.

Lightning protection of tank batteries, disposal pump motors and motor controls have a higher priority that ESPs. When this equipment is damaged, it is impossible to dispose of produced water quickly and reliably. This likewise reduces or stops production. Loss of production from an individual well is normally far less significant than loss of either a tank battery or disposal pump. Still, it can take days or weeks to get back to the same production rate after a replacement ESP is installed. This makes an ESP failure very costly when added to the expense of a replacement pump, rig, rig crew and lost production during down time.

ESP's are particularly prone to lightning damage because they operate in a solidly grounded environment at the bottom of an oil well surrounded by salt water. Further, an ESP is subjected to extreme voltages when operated at the end of a distribution feeder, where a voltage transient (such as those caused by lightning) will double in size from reflection at the end of the line. Protection from these and other conditions is possible if: i) TVSS or SPD is properly designed, i.e., with a fourth ground wire; ii) the wellhead is used as the primary ground; iii) lightning arresters and TVSS are on separate ground wires only connected together at the wellhead; iv) transformer windings feeding the ESP are ungrounded except for the TVSS; v) the TVSS is mounted on the junction box; and/or vi) for electric distribution constructed with an overhad shield (neutral) wire that shield wire should only connect to the lightning arresters and the pole ground so as not to conflict with iii) above.

Variable speed drives powering ESP's are quite expensive to repair. These drives typically are high horsepower and designed specifically for ESP operations. This is a fourth priority. If parts are available, downtime can be kept to a minimum. Unlike the ESP, the drive is very accessible.

Pumping units are less important to protect against lightning damage. Motor rewinds and control failures can be greatly reduced with a TVSS. Many of the same grounding principles that work for ESP's are applicable for pumping units. Normally the pumping rate is low compared to an ESP, and lost production during downtime is minimal. Gas well dewatering may take a few days to recover.

It is therefore desirable to provide a wellhead mounted transient voltage surge suppression and method of use thereof that results in less lost production, fewer lost man-hours, and lower equipment replacement and repair costs.

It is further desirable to provide an explosion-proof TVSS incorporated into a wellhead power feed-through penetrator or mandrel in order to position the surge suppressor in very close proximity to the oil well equipment to be protected.

It is still further desirable to provide an explosion-proof TVSS incorporated into a wellhead power feed-through penetrator or mandrel. Other devices, e.g., surge capacitors and series inductors, can be incorporated away from the wellhead to slow the rate-of-voltage rise.

### BRIEF SUMMARY OF THE INVENTION

In general, the invention relates to a wellhead mounted transient voltage surge suppressor for superior voltage impulse protection of electric submersible pump motors and power cables. The invention involves incorporating a TVSS into a wellhead power feed-through penetrator or mandrel so that a very short connection can be made to the wellhead. The TVSS is housed within an explosion-proof penetrator because of the explosive wellhead environment. The TVSS can be attached directly to the penetrator or can be incorporated directly into the packer penetrator pipes along with the power wires.

### BRIEF DESCRIPTION OF THE DRAWINGS

FIG. 1 is an elevation view of a prior art ESP grounding with a single ground wire;

FIG. 2 is an elevation view of a prior art ESP grounding with a switchboard operated ESP;

FIG. 3 is a wiring diagram of a prior art TVSS for lightening protection;

FIG. 4 is an elevation view of an example of an explosion-proof TVSS incorporated into a wellhead power feed-through penetrator or mandrel in accordance with an illustrative embodiment of the wellhead mounted transient voltage surge suppression and method of use thereof disclosed herein;

FIG. 5 is a partial cross-sectional view of an example of a wellhead power feed-through penetrator or mandrel in accordance with an illustrative embodiment of the invention disclosed herein; and

FIG. 6 is an exploded view of the penetrator shown in FIG. 5.

Other advantages and features will be apparent from the following description and from the claims.

### DETAILED DESCRIPTION OF THE INVENTION

The embodiments discussed herein are merely illustrative of specific manners in which to make and use this invention and are not to be interpreted as limiting in scope.

While the invention has been described with a certain degree of particularity, it is to be noted that many modifications may be made in the construction and the arrangement of its components without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms, such as “connected,” “connecting,” “attached,” “attaching,” “join” and “joining” are used interchangeably and refer to one structure or surface being secure to another structure or surface or integrally fabricated in one piece or to electrical connections.

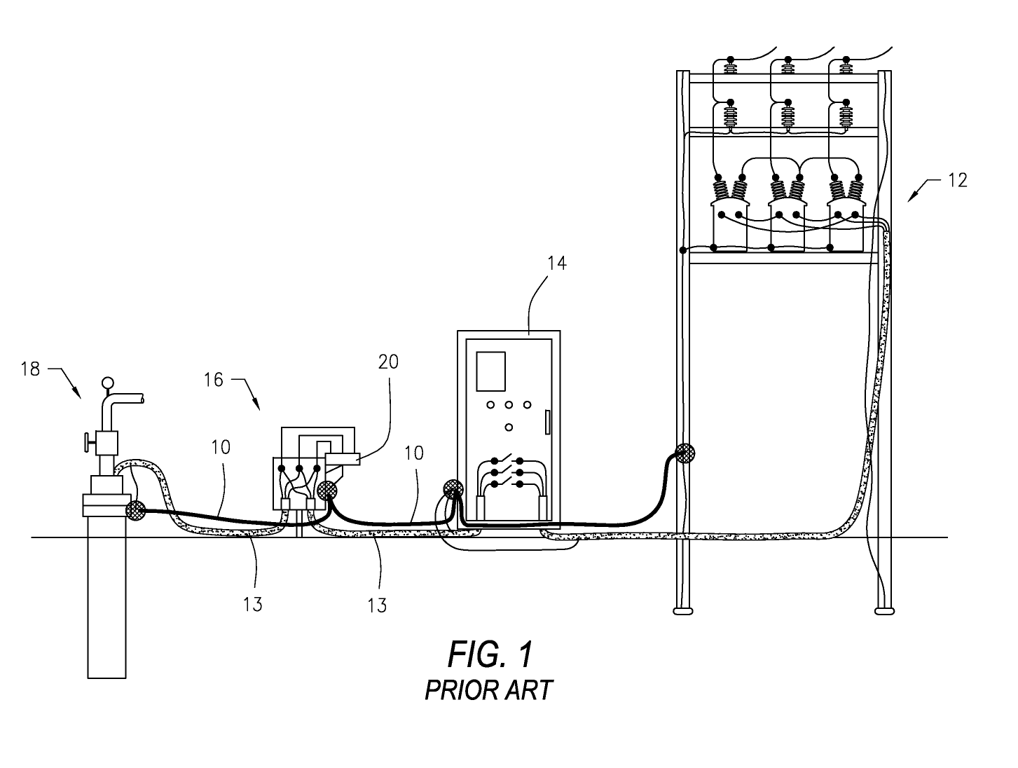

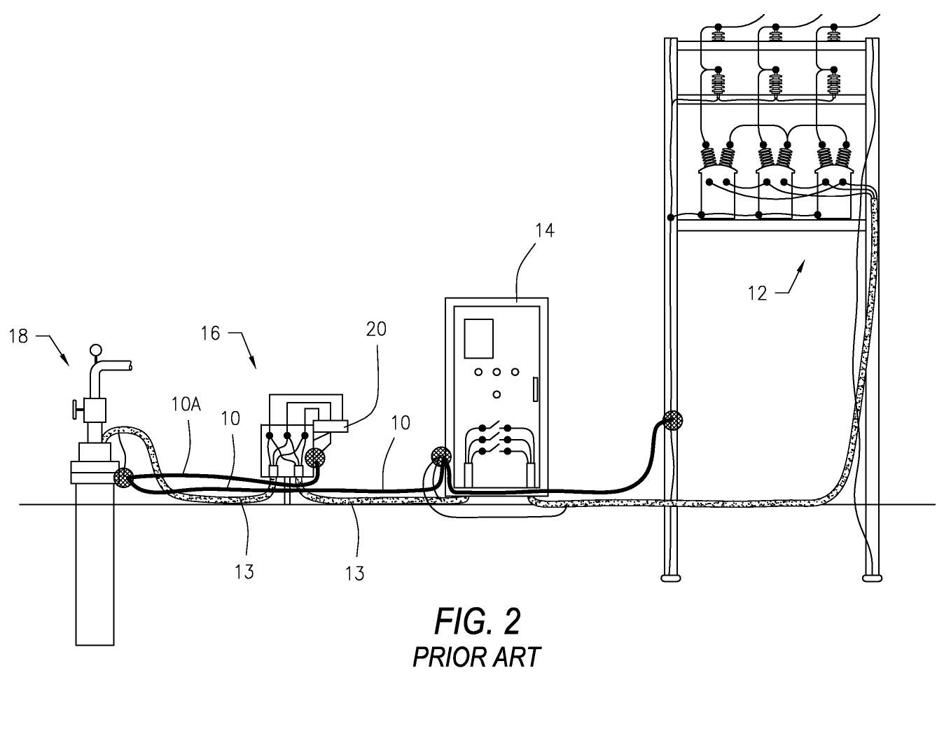

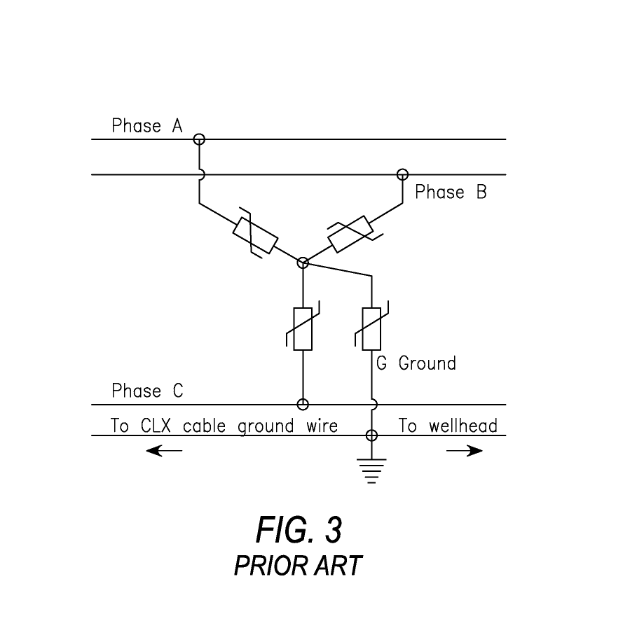

Referring to the figures of the drawings, wherein like numerals of reference designate like elements throughout the several views, and initially to FIGS. 1 through 3 depicting prior art groundings and a wiring diagram for lightning protection for downhole equipment. Typically, a single ground wire 10 runs from one or more transformers 12 to a switchboard 14 to a junction box 16 to a wellhead 18 as illustrated in FIG. 1. Prior to the invention disclosed herein, installing a TVSS 20 on the junction box 16 was as close to the wellhead 18 as possible. Often the TVSS 20 is mounted on the switchboard 14; however, a lightning strike will elevate the voltage all along the ground wire 10 causing the TVSS 20 to damage, rather than protect, the downhole motor and cable (not shown). This incident pulls the TVSS ground connection to extreme voltages (either positive or negative), and the phase wires illustrated in FIG. 3 are pulled along too, albeit at a slightly different voltage produced by the TVSS 20 threshold. FIG. 3 illustrates a 4-mode TVSS, but it could also be a 6-mode TVSS having a delta with a Y inside, three phase-to-phase and three phase-to-ground. Another known method for lightning surge suppression is the switchboard 14 operated TVSS 20 for ESPs. As exemplified in FIG. 2, lightning arresters and transformers 12 are on one ground wire 10 that goes straight to the wellhead 18 (power system ground wire) and a second ground wire 10A (ESP system ground wire) connects TVSS 20 to the wellhead 18. By connecting TVSS 20 and lightning arrester on separate ground wires 10 and 10A which are only connected together at the wellhead 18, interaction between them can be eliminated and effectiveness of surge protection greatly improved. The separate power system and TVSS ground wires 10 and 10A prevent backward conduction through the TVSS 20 and possible ESP damage. The power system ground 10 connects to the switchboard 14 and cable armors, and goes directly to the wellhead 18 without contacting the junction box 16.

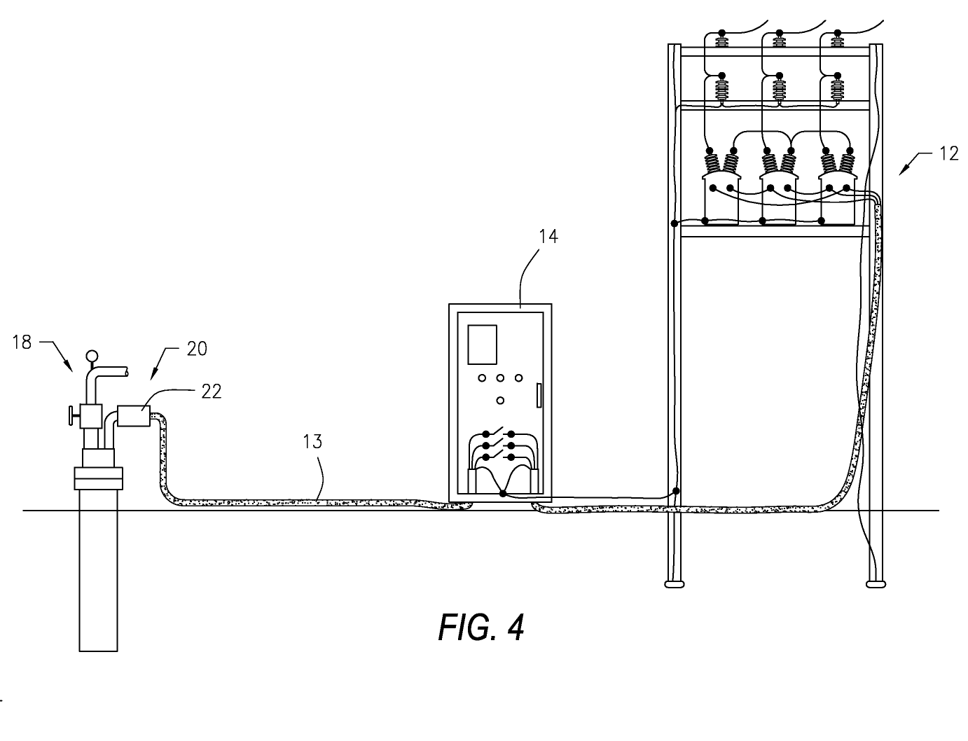

Turning now to FIGS. 4 through 6, the TVSS 20 is incorporated into the wellhead 18 using an explosion-proof, power feed-through penetrator or mandrel 22 in accordance with an illustrative embodiment of the wellhead mounted transient voltage surge suppression and method of use thereof disclosed herein. The explosion-proof TVSS 20 is mounted internally or attached externally directly to the packer penetrator 22, and grounded directly to the wellhead 18. The grounded CLX cable 13 has internal ground wires to provide grounding back to the switchboard 14 and power system 12. The CLX cable 13 used with the packer penetrator 22 carries three ground wires and is armored with metal and covered with an epoxy. The internal ground wires 10 connect back to the switchboard 14 and power system 12, thereby eliminating the multiplicity of ground wires 10 shown in FIGS. 1 and 2. The invention places the TVSS 20 within the packer penetrator 22 at the wellhead 18, which is as close as possible to the equipment to be protected, and eliminates the need for the junction box 16. In addition, the packer penetrator 22 has capability to vent natural gases that might migrate to electrical equipment through the power cable and cause explosions.

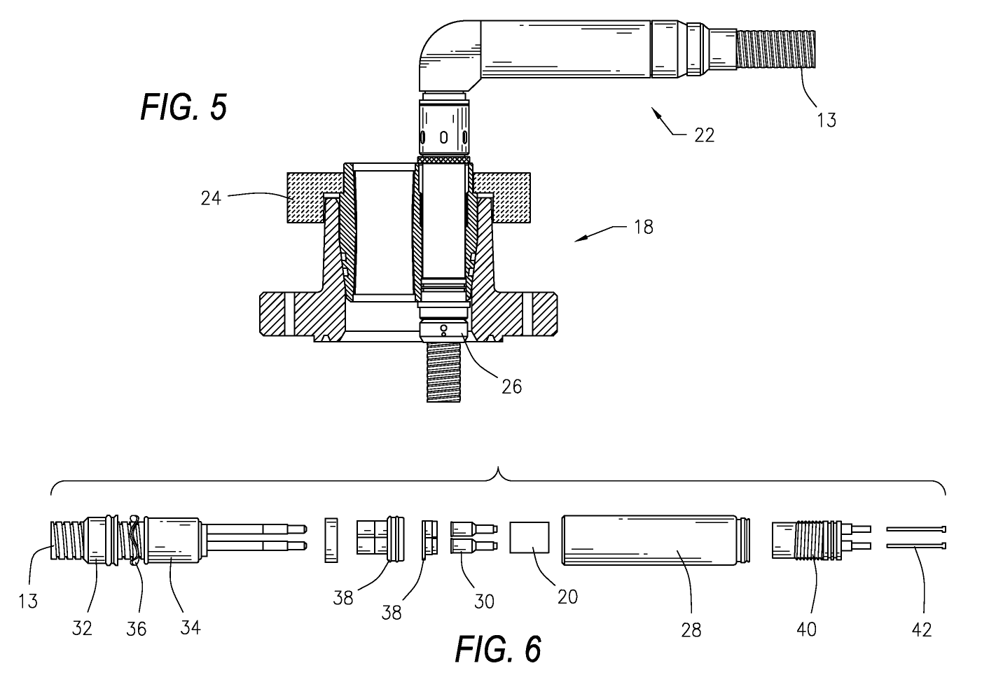

As exemplified in FIGS. 5 and 6, the explosion-proof TVSS 20 is mounted internally in the packer penetrator 22 directly at the wellhead 18, and is passed through a knock off cap 24 and secured using a feed connector 26. The explosion-proof TVSS 20 is incorporated into the wellhead 18 power feed-through penetrator 22 and housed within a body shell 28 with conductor terminals 30. An armor adaptor 32 connects the grounding cable 10 to a driver sleeve 34 using a wave spring 36. A main and secondary cable seal 38 are seated intermediate of the driver sleeve 34 and the body shell 28. A male poly ether ether ketone (PEEK) 40 may also be installed within the body shell 28 and secured using set screws 42.

In addition, more complicated variable speed drive applications also benefit from a reduction in ground wires provided by the wellhead mounted transient voltage surge suppression and method of use thereof disclosed herein. The ground cable 10 should connect to the variable speed drive (not shown), and a separate ground wire should connect the lightning arreter on the pole to the wellhead 18.

Whereas, the embodiments have been described in relation to the drawings, it should be understood that other and further modifications, apart from those shown or suggested herein, may be made within the scope of this invention.

What is claimed is:

1. A wellhead mounted transient voltage surge suppression apparatus, comprising:
an explosion-proof transient voltage surge suppressor mounted internally or attached externally to a packer penetrator directly on a wellhead.

2. The apparatus of claim 1 wherein said transient voltage surge suppressor is incorporated directly into said packer penetrator along with power wires.

3. The apparatus of claim 1 wherein said transient voltage surge suppressor is housed within an explosion-proof box inside or attached to said packer penetrator.

4. A method of lightning strike protection for oil well equipment, said process comprising the steps of:
mounting an explosion-proof transient voltage surge suppressor to a packer penetrator directly on a wellhead.

5. The method of claim 4 further comprising the step of:
internally or attached externally mounting said explosion-proof transient voltage surge suppressor to said packer penetrator.
